(19) United States
(12) Patent Application Publication
(10) Pub. No.: US 2003/0114173 A1
(43) Pub. Date: Jun. 19, 2003

(54) System and method of rapidly obtaining, processing, and disseminating geospatial data

(76) Inventor: Ernest A. Carroll, Herndon, VA (US)

Correspondence Address: ERNEST A. CARROLL, 12913 Alton Square, No. 114, Herndon, VA, 20170, US

(21) Appl. No.: 10/015,781

(22) Filed: Dec. 17, 2001

(51) Int. Cl. H04Q 7/20

(52) U.S. Cl. 455/457

(57) ABSTRACT

A system and method of utilizing aerial image capture technology such as digital cameras carried aboard satellites, processing digitized data derived therefrom, and rapidly disseminating the processed data to remote locations by existing commercial communications systems and radio telecommunication via commercial communications satellites for dissemination of processed data to a remote receiving site. Images obtained from imagery satellites are transmitted by radio to a receiver in communication with the Internet. A computer connected to the Internet receives and selectively modifies raw imagery data. Modified images are transmitted over the Internet either directly to a user for download, or alternatively to a radio transmitter which transmits corresponding signals to a commercial communications satellite. The satellite in turn transmits signals to a ground receiving station. A computer in communication with the ground receiving station then generates visual images incorporating the modifications on a screen such as a CRT or flat screen, or prints out the images. Image modification includes data compression and decompression, geocoding images, orthorectifying images, and adding data from a storage medium. Illustratively, added data includes features such as roads and political boundaries, among others, to the raw image.

### REFERENCE TO RELATED APPLICATION

This application is related to Ser. No. 09/662,903, filed Sep. 15, 2000.

### BACKGROUND OF THE INVENTION

1. Field of the Invention

The present invention relates to obtaining and disseminating data related to geospatial images. More particularly, the invention is a system and method of utilizing aerial image capture technology, such as digital cameras carried aboard satellites, processing digitized data derived therefrom, and rapidly disseminating the processed data to remote locations by existing commercial communications systems and radio telecommunication via commercial communications satellites for dissemination of processed data to a remote receiving site.

2. Description of the Prior Art

Those engaged in planning, forming policies, and undertaking diverse projects involving land use frequently resort to utilizing representations of large areas of land, such as maps showing selected relevant features of the land. The types of information conveyed by maps include boundaries, geographic features such as bodies of waters and mountains, and artificial features such as highways, bridges, and buildings. Aerial imagery has been exploited as a source of information which may be incorporated into maps. For example, satellite and aircraft reconnaissance have provided many photographic images providing detail not readily acquired in other ways.

Ready storage, transmission, reproduction, and dissemination of information has resulted from emerging electronic technologies such as electronic data processing and telecommunications advances. The latter includes communication satellites. Transmission of geospatial imagery and data by radio frequency signals, and reproduction of images on cathode ray tube and flat panel screens is known. An example is seen in the Eagle Vision system employed by the United States military establishment to deliver commercial imagery to deployed military personnel. This system enables rapid updating of old and obsolescent records of large areas, such as paper or digitized maps. The Eagle Vision system provides unmodified images of areas of interest to the military.

Unmodified images suit many military purposes, such as determining whether, for example, a bridge has been destroyed by bombing. However, unmodified images may fail to address needs in other situations. For example, in the field of fighting forest fires, it may be necessary to consider several images to obtain useful information, to provide highly precise images of areas free of distortion arising from angle of view, such as parallax distortions, and to identify the exact terrestrial location of each image. In the example of the bridge, the precise location is not necessary. It is merely necessary to determine whether the bridge remains intact. But in fluid situations lacking a single visually recognizable subject such as a bridge, more precise identification of the location of an image is frequently demanded. Also, the image may require orthorectification to be sufficiently precise to be useful. This is not necessary in determining whether a bridge has been destroyed, but may well be necessary in, for example, identifying fire front lines.

In some image acquisition processes, images are arranged or taken by layers of information. Such images have equivalent geographic coverage, but capture different characteristics. For example, multispectral imagery includes layers of data taken at different frequency bands. Each image data layer conveys different information to the observer. In the example of forest fires, images derived only from visible portions of the spectrum may reveal only a cloudy smoke cover. However, images based on infrared bands will reveal underlying conditions including flame front lines.

Neither the above imagery system nor present practice in the field of commercial geospatial imagery, taken either singly or in combination, is seen to describe the instant invention as claimed.

### SUMMARY OF THE INVENTION

The present invention provides a system and method of rapidly delivering geospatial imagery and related data to a user who may be remote from the area of interest. The system and method improve over conventional satellite imagery providers by utilizing a local image acquisition resource which overflies a target area on demand and is not limited by cloud cover and by orbital limitations. The system and method improve over conventional aircraft imagery platforms which rely upon development of film and which require landing to download digitized imagery data.

In the novel system, images and related data are taken of a designated geographic coverage area. Resulting direct and modified images are mosaicked and otherwise selectively modified, and are delivered typically within two to four hours in digitized form over an existing communications channel such as the Internet to a widespread audience of potential users. Final costs to the user are the lowest available in the current commercial market. The step of utilizing a communications channel such as the Internet is not currently practiced in the field of commercial imagery.

The area of coverage may include large land masses such as a county or state or the entire continental United States (or, of course, other land masses such as countries and the open ocean). A master data management program, preloaded into the computer maintaining the database, supports a plurality of available formats, such as GeoTIFF, jpg, TIFF, and NITF, among many others. The user may designate desired layers of data within the selected geographic boundary, select a desired format, and have a single nearly seamless mosaicked image of the selected area automatically generated and delivered to a site which may be remote from both the area of interest and also remote from a permanently located data processing center. The output of the inventive system may ultimately be loaded into the user's computer or other data processing device for ultimate use.

Data is preferably obtained from an aerial view source of images such as a commercial imagery satellite, surveillance aircraft, or other downward looking sources. Imagery and related data are transmitted to a ground station, transmitted to a stationary central processing station, modified to suit requirements of the ultimate user, and the processed results are transmitted to the site of the user. Alternatively, imagery and data may be transmitted to a ground uplink station and retransmitted to a commercial communications satellite for retransmission to a ground receiving station under the control of or in the possession of the ultimate user. The ground receiving station generally includes a data processor including a suitable output device such as a monitor having a cathode ray tube, a flat screen display, a printer, or other apparatus enabling graphic reproduction of the images and data, or a combination of these. It will be appreciated that relatively rapid transmission of imagery to many widely dispersed locations is economically accomplished.

Accordingly, it is one object of the invention to provide geospatial imagery in digital form expeditiously to a widespread audience utilizing existing publicly available commercial data transmission systems.

Another object of the invention is to reduce both turnaround time required to generate images in their final desired form and to reduce cost of obtaining geospatial images.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a schematic, pictorial diagram of the apparatus employed to practice the invention.

FIG. 2 is a diagram of apparatus employed in prior art practice.

### DETAILED DESCRIPTION OF THE PREFERRED EMBODIMENTS

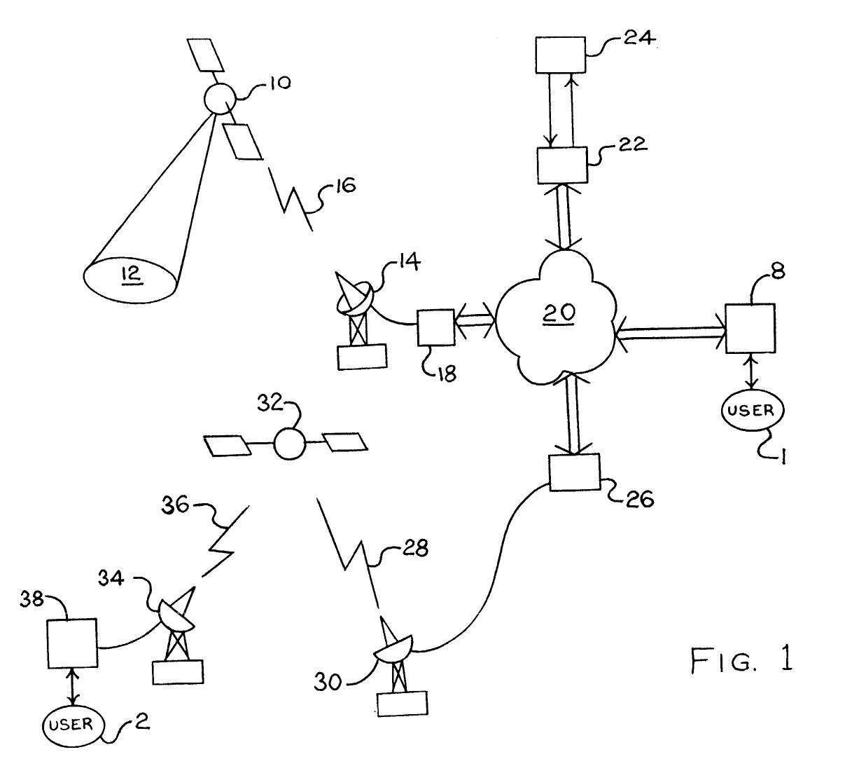

FIG. 1 of the drawings illustrates apparatus employed in the novel system and method for rapidly obtaining geospatial data, processing the geospatial data, and disseminating the geospatial data to an ultimate user. A suitable downward looking collection platform or aerial view source of geospatial images and data, such as commercial imagery satellite 10, is given commands to capture imagery and associated data. This is done by uplinked radio frequency commands which ultimately cause satellite 10 to operate an onboard digital camera (not separately shown). The peripheral bounds of one captured image is shown diagrammatically as 12. One or more images are captured and utilized in the following way. Digitized data is transmitted in radiant energy form to a receiver 14 on the earth. Preferably, data is transmitted as radio frequency signals 16, but could be transmitted using optical or any other suitable form of radiant energy.

Receiver 14 receives transmitted digitized data. Receiver 14 is operated with associated apparatus, such as a computer 18 which generates communication signals (not shown) corresponding to the digitized geospatial data. The communications signals are then transmitted over a communications channel 20, which in the preferred embodiment is the Internet. It will be understood that any wide area communications system, such as commercially available and large scale private and government communications systems including wired, optical, radio frequency, and other links may be alternatively employed for data communications. The Internet and other wide area communications systems enable a wide spread user base including plural widely dispersed individual parties to be served as ultimate users independently of one another.

A data processor 22 placed in communicable connection to communications link 20 receives the communication signals. Data processor 22 converts communications signals to digitized data in a format which can be processed by a computer or other data processor. Data corresponding to the raw imagery and other associated data are then selectively modified by data processor 22. Modification may include any of the following processes.

The data is optionally compressed for efficient transmission and handling, and is subsequently decompressed, as described hereinafter. Another form of processing includes geocoding the digitized data. Geocoding signifies that pixel locations of each image are correlated with corresponding geographic locations on the globe in a manner enabling each image to be identified as to geographic location when the image is retrieved from the digitized data and is reproduced in visible format. A further optional process includes subsequently adding stored data derived from a source other than the aerial view source to the digitized data in a manner enabling visual comparison between an image captured by the aerial view source and the stored data. In an example, roads and political divisions such as county and state borders may be superimposed over direct images of the earth. Still another optional process is that of orthorectifying images captured by the aerial view source. Orthorectification signifies that images are modified to appear as though camera angles are perpendicular to the area of interest, with the camera being located directly thereabove. The effect or orthorectification is to eliminate parallax and like sources of distortion to the final image. In a further optional process, plural images can be united in a mosaicked master image. Band frequencies can be selected for reproduction in still another optional process. That is, band frequencies may be removed from the sum total data of the captured images. Still other manipulations of images can be performed if desired.

A data file covering a much greater area than that being captured is stored in a suitable memory device 24. The data file includes features deemed likely to be of interest, so that images can be modified as described above within a very short time by relying upon data which has been obtained and stored prior to the initial images being captured. The data file includes those features which are superimposed, and also includes software enabling orthorectifying, mosaicking, and other known techniques of manipulating data pertaining to imagery.

After selectively modifying data as desired, modified data is transmitted through communications channel 20 to the final users 1, 2. The final user, if operably connected to communications channel 20, may simply download the data therefrom via suitable processing equipment such as computer 8. In some cases, and as illustrated in FIG. 1, final user 2 is located remotely from facilities connected to the preferred communications channel 20, i.e., the Internet. In the latter case, and as shown in FIG. 1, modified data is transmitted through communications channel 20 to a radiant energy transmitter. It will be understood that the apparatus includes a converter 26 capable of converting digitized data to radiant energy signals such as radio frequency signals 28, and a radio frequency transmitter 30. Signals 28 are transmitted to a commercial communications satellite 32, then are retransmitted by satellite 32 to a radiant energy receiver such as radio receiver 34 located remotely from the point of retransmission and proximate to the ultimate user of the geospatial data. Data transmission is most likely to be performed by radio frequency signals 28 and subsequently retransmitted radio frequency signals 36, but of course may take any other suitable form of radiant energy such as laser light or still other forms.

Data may be recovered in other ways. For example, hyperspectral data may prove too onerous for ready transmission without intruding on other users of the ether. In such cases, it is possible to record data on media such as discs and magnetic tapes, and to retrieve the medium upon landing of the downward looking data collection platform.

Radio receiver 34 receives digitized data signals 36 which are then converted to electrical signals usable by data processing equipment such as computers. An output device capable of processing the electrical signals, such as computer 38, is placed in communication with receiver 34. Computers 8, 38 will be understood to incorporate a suitable visual element such as a cathode ray tube, flat screen display, or printer, or any combination of these (none separately shown), so that when the computer 8 or 38 is caused to receive the electrical signals, the visual element generates a visual output representative of modified geospatial images. Data decompression may be accomplished at data processor 22, at converter 26, or at computer 8 or 38.

An exemplary application of the novel process is found in agriculture. A practice known as precision farming, the goal of which is to allocate resources such as fertilizers, pesticides, water, seed, and the like, and to schedule operational steps such as planting, applying fertilizers and the like, pruning, and harvesting, and even estimating crop yields, may rely heavily upon aerial imagery. A specialist in imagery acquisition and analysis, who may be for example a representative of a firm which gathers and interprets imagery, works in concert with individual farmers. The agent meets with a farmer to determine geographic bounds of each field being analyzed, and to define types of prescriptive and descriptive data. Prescriptive data is that which determines future agricultural operations, for example, bearing on where to apply fertilizer and in what quantities. This data is subsequently used by a machine which applies fertilizer. Descriptive data is that relating to visual presentations, such as maps and other graphical depictions which may be generated from collected data. In the agricultural example, the final image may indicate local areas of deficiency of fertilizer, and may separate fields of different crops.

The step of collecting data may be modified from mere imagery data recording to encompass mission planning to implement acquisition of data, for example, providing or planning guidance to a controllable aircraft used as an image acquisition platform, and to determine types of prescriptive and descriptive data, and to encompass further retrieval of data, for example, transmission of data from the imagery acquisition platform to a ground station by wire, by radio frequency communication, or by any other suitable method. The method may, and preferably does, include utilizing the Internet as a link in the line of communication.

The step of processing of data encompasses both manipulation of just-gathered data and also addition of stored data to arrive at certain desirable goals, such as geocoding, orthorectification, and processing for prescriptive and descriptive products. For example, a pictomap merging colored imagery with grid lines may be generated. Prescriptive and descriptive data may be rendered in a format useful to the specialist, who can then work with the farmer to implement improvements to farming procedures. It may be necessary for the farmer to work with the specialist in order to understand and apply the finished imagery product.

In the above example, farming exemplifies a commercial operation which may be modified from the procedure that would be followed in the absence of aerial data. In the modified procedure, prescriptive data is applied to farming operations. In an example, imagery is employed to program an agricultural machine (not shown) such as a tractor utilized to apply fertilizer where to apply the fertilizer and in what quantity, where the rate of application is adjustable. It should be noted that manufacturers of large scale agricultural machines are now being provided with programmable controllers which can interact with the Global Positioning System, for the purpose of enabling such modifications to operations.

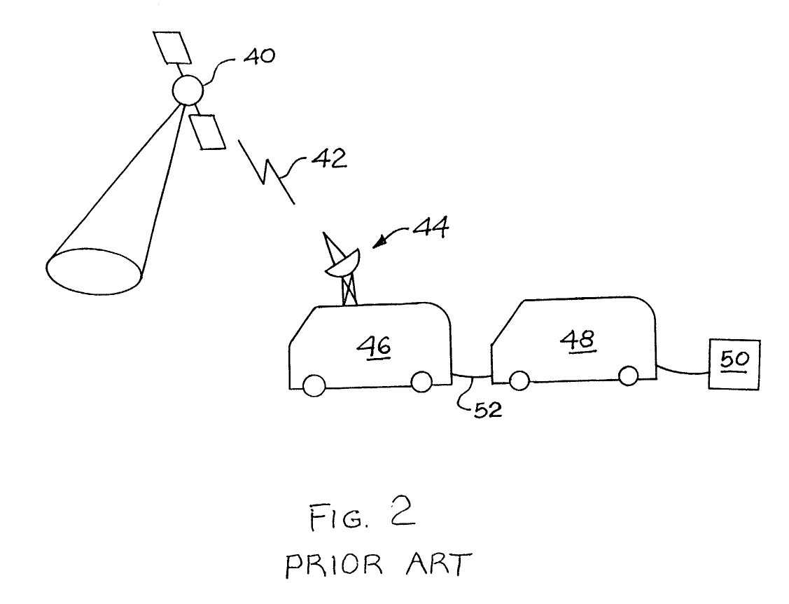

FIG. 2 illustrates a prior art image retrieval system known as “Eagle Vision” employed by the U.S. military establishment, wherein initial images are captured from a commercial imaging satellite 40. Satellite 40 sends imagery data as signals 42 to a movable earth bound receiver 44 associated with motor vehicle 46. The apparatus of the Eagle Vision system is carried aboard motor vehicles 46, 48, and includes data processing equipment shown diagrammatically as computer 50. It should be noted that vehicles 46, 48 are physically connected by a hard wired communications cable 52.

The Eagle Vision system appears to be considerably more direct than the present invention. However, the Eagle Vision system is predicated upon transporting two vehicles 46, 48 to a designated location where data is to be evaluated or otherwise utilized. Even assuming that transport time is not factored in, the developer of Eagle Vision asserts that delivery time for geocoded imagery is on the order of twelve hours. By contrast, the present invention reduces this turnaround time considerably, and at considerably less cost.

The present invention anticipates that commercial imagery satellites will be the principal carriers of image capture apparatus such as digital cameras. However, the invention is equally applicable to manned and unmanned powered aircraft, rockets, gliders, balloons, and even static structures such as mountains, towers, bridges, and skyscrapers, as well as other support platforms for the image capture apparatus, depending upon the application

The inputs of collected or acquired geospatial data may be based on cameras, or may take other forms. For example, magnetometers and gravitometers may be employed instead of or in addition to cameras, with their respective readings being digitized for transmission and exploitation.

The output may take any convenient form. For example, rather than being a reproduction on a screen of a cathode ray tube or flat screen display such as a liquid crystal display, the output may comprise light rays projected onto a motion picture screen, may be presented as a hologram, may be printed on a printer, or may take any other desired form.

It is to be understood that the present invention is not limited to the embodiments described above, but encompasses any and all embodiments within the scope of the following claims.

I claim:

1. A method of rapidly obtaining geospatial data, processing the geospatial data, and disseminating the geospatial data to at least one ultimate user, comprising the steps of:
obtaining digital data corresponding to geospatial images from a downward looking collection platform, and transmitting the digital data to the earth;
receiving transmitted digitized data, generating communication signals corresponding to the digitized geospatial data, and transmitting the communication signals over a communications channel;
receiving the communication signals at a data processor coupled to the communications channel;
converting the communication signals to digitized data;
selectively modifying the digitized data by adding data derived from at least one other source; and
transmitting modified digitized data through the communications channel to a user.

2. The method according to claim 1, wherein the steps of transmitting and receiving communications signals and transmitting modified digitized data through a communications channel include the further step of transmitting and receiving the communications signals and transmitting the modified digitized data over the Internet.

3. The method according to claim 1, wherein said step of transmitting modified digitized data to an ultimate user includes the further steps of:
transmitting modified digitized data through the communications channel to a radiant energy transmitter;
transmitting the modified digitized data to a commercial communications satellite in the form of radiant energy; and
retransmitting the modified digitized data as radiant energy to a radiant energy receiver located remotely from the point of retransmission, wherein the radiant energy receiver is proximate the ultimate user of the geospatial data.

4. The method according to claim 1, wherein said step of obtaining digital data corresponding to geospatial images from a downward looking collection platform, and transmitting the digital data to the earth comprises the further step of transmitting the digital data to the earth in radiant energy form.

5. The method according to claim 1, comprising the further steps of:
providing an output device capable of receiving and processing the modified digitized data;
causing the output device to receive and process the modified digitized data; and
generating a visual output representative of modified geospatial images by the output device.

6. The method according to claim 5, wherein said step of providing an output device comprises the further step of providing a computer and an operably associated monitor, and wherein said step of generating a visual output comprises the further step of generating a visual image on the monitor.

7. The method according to claim 5, wherein said step of selectively modifying the digitized data comprises the further step of compressing the digitized data, and said step of causing said output device to receive and process the modified digitized data comprises the further step of decompressing the digitized data.

8. The method according to claim 1, wherein said step of selectively modifying the digitized data comprises the further step of geocoding the digitized data, wherein pixel locations of at least one image are correlated with corresponding geographic locations on the globe in a manner enabling each image to be identified as to geographic location when the image is retrieved from the digitized data and is reproduced in visible format.

9. The method according to claim 1, wherein said step of selectively modifying the digitized data includes the further steps of
subsequently adding stored data derived from a source other than the aerial view source to the digitized data in a manner enabling visual comparison between an image captured by the aerial view source and the stored data, and
generating an image from the digitized data which image includes both data corresponding to geospatial images obtained from the downward looking collection platform and also subsequently added stored data.

10. The method according to claim 1, wherein said step of selectively modifying the digitized data includes a further step of orthorectifying images captured by the aerial view source.

11. The method according to claim 1, wherein said step of obtaining geospatial images from an aerial view source comprises the further step of obtaining geospatial images from a commercial imagery satellite.

12. The method according to claim 1, including further steps of:
providing a guidable image acquisition platform capable of; and
providing guidance to the image acquisition platform prior to obtaining digital data corresponding to geospatial images.

13. The method according to claim 1, including the further step of applying prescriptive data to a commercial operation.

14. Apparatus for rapidly obtaining geospatial data, processing the geospatial data, and disseminating the geospatial data to at least one ultimate user, comprising:
an aerial view source of geospatial images having a first transmitter, disposed to obtain geospatial images, to render the geospatial images as digital data, and to transmit the digital data in radiant energy form to the earth;
a first radiant energy receiver located remotely from said aerial view source, disposed to receive digital data from said aerial view source, to generate corresponding communication signals, and to transmit the communications signals;
a communications channel disposed in communicable relation to said radiant energy receiver; and
a data processor communicably connected to said communications channel, disposed to receive the communications signals, to selectively modify the digitized data, and to transmit selectively modified data to a user.

15. The apparatus according to claim 14, wherein said communications channel includes the Internet.

16. The apparatus according to claim 14, further comprising:
an output device communicably coupled to said communications channel, disposed to render the selectively modified digital data in a graphical form.

17. The apparatus according to claim 16, wherein said output device includes a computer and an operably associated monitor.

18. The apparatus according to claim 14, further comprising:
a transmitter communicably coupled to the communications channel, disposed to transmit the selectively modified digitized data to a commercial communications satellite in the form of radiant energy; and
a second radiant energy receiver located remotely from said data processor, disposed to receive the selectively modified digital data as radiant energy signals from the commercial communications satellite, and an output device communicably connected to said second radiant energy receiver, disposed to render the digital data in visible form.

19. The apparatus according to claim 18, wherein said output device includes a computer and an operably associated monitor.

20. The apparatus according to claim 14, wherein said aerial view source of geospatial images is an imagery satellite incorporating a digital camera, disposed in earth orbit.
